(19) United States
(12) Patent Application Publication
(10) Pub. No.: US 2017/0253988 A1
(43) Pub. Date: Sep. 7, 2017

(54) Electromodification of Conductive Surfaces

(71) Applicant: The Boeing Company, Chicago, IL (US)

(72) Inventor: Erin K. Anderson, Huntsville, AL (US)

(73) Assignee: The Boeing Company, Chicago, IL (US)

(21) Appl. No.: 15/057,811

(22) Filed: Mar. 1, 2016

(51) Int. Cl. C25D 17/00; C25D 5/02; B41N 1/24

(52) U.S. Cl. CPC C25D 17/005; B41N 1/248; C25D 5/022

(57) ABSTRACT

An apparatus for electromodification of a conductive surface of a part may comprise a stencil having a mask pattern, a retainer joined to the stencil and configured to capture an electrolyte, and a sacrificial metal joined to the stencil and the retainer for form an integrated assembly. The stencil may be positioned in the assembly to contact the conductive surface of the part, and establish electrical contact between the electrolyte and the conductive surface through the mask pattern when electrical power with a predetermined polarity is applied between the sacrificial metal and the conductive surface.

### FIELD

The present disclosure generally relates to systems for electromodification of conductive surfaces, and more specifically, to systems for bathless electromodification of conductive surfaces.

### BACKGROUND

Electroetching or electrodepositing markings on a conductive surface of a part may involve immersing a masked part and a sacrificial metal in an electrolyte bath, and applying an electrical power polarity between the part and the sacrificial metal. However, when applying markings on a large or installed part, it may be challenging to provide a sufficiently large electrolyte bath and/or to submerge the part in the bath.

### SUMMARY

In accordance with one aspect of the present disclosure, an apparatus for electromodification of a conductive surface of a part is disclosed. The apparatus may comprise a stencil having a mask pattern, a retainer joined to the stencil and configured to capture an electrolyte, and a sacrificial metal joined to the stencil and the retainer for form an integrated assembly. The stencil may be positioned in the assembly to contact the conductive surface of the part, and establish electrical contact through the mask pattern between the electrolyte and the conductive surface when electrical power with a predetermined polarity is applied between the sacrificial metal and the conductive surface.

In accordance with another aspect of the present disclosure, a method for electromodification of a conductive surface of a part is disclosed. The method may comprise providing an electromodification apparatus including a stencil having a mask pattern, a retainer supporting an electrolyte, a sacrificial metal, and a frame holding the stencil, the retainer, and the sacrificial metal together as an integrated assembly. The method may further comprise placing the stencil of the apparatus in contact with the conductive surface and applying electrical power with a predetermined polarity between the sacrificial metal and the conductive surface. The stencil may establish electrical contact between the electrolyte and the conductive surface through the mask pattern. The method may further comprise allowing electromodification of the conductive surface by one of electroetching the conductive surface, and electrodeposition of metal on the conductive surface.

In accordance with another aspect of the present disclosure, a bathless electromodification system for electromodification of a conductive surface is disclosed. The bathless electromodification system may comprise a part having the conductive surface and an electromodification apparatus. The electromodification apparatus may include a stencil in contact with the conductive surface of the part and having a mask pattern, a retainer capturing an electrolyte, a sacrificial metal, and a non-conductive frame holding the stencil, the retainer, and the sacrificial metal together as an integrated assembly. The bathless electromodification system may further include a power supply to apply electrical power with a predetermined polarity between the sacrificial metal and the conductive surface to allow electromodification of the conductive surface. The stencil may establish electrical contact between the electrolyte and the conductive surface through the mask pattern.

The features, functions, and advantages that have been discussed can be achieved independently in various embodiments or may be combined in yet other embodiments further details of which can be seen with reference to the following description and drawings.

### BRIEF DESCRIPTION OF THE DRAWINGS

FIG. 1 is a schematic view of a bathless system for electromodification of a conductive surface, with an electromodification apparatus shown in cross-section, constructed in accordance with the present disclosure.

FIG. 2 is a schematic view of the bathless electromodification system of FIG. 1 with a predetermined polarity of an electrical power reversed, constructed in accordance with the present disclosure.

FIG. 3 is top view of the electromodification apparatus in isolation, constructed in accordance with the present disclosure.

FIG. 4 is a bottom view of the electromodification apparatus, constructed in accordance with the present disclosure.

FIG. 5 is a schematic view of a bathless electromodification system similar to FIG. 1 but having a backing on a frame of the electromodification apparatus, constructed in accordance with the present disclosure.

FIG. 6 is a schematic view of a bathless electromodification system similar to FIG. 5 but with a sacrificial metal having a different position in the electromodification apparatus, constructed in accordance with the present disclosure.

FIG. 7 is a flowchart illustrating a sample sequence of steps that may be involved in electromodifying the conductive surface using the electromodification apparatus, in accordance with a method of the present disclosure.

### DETAILED DESCRIPTION

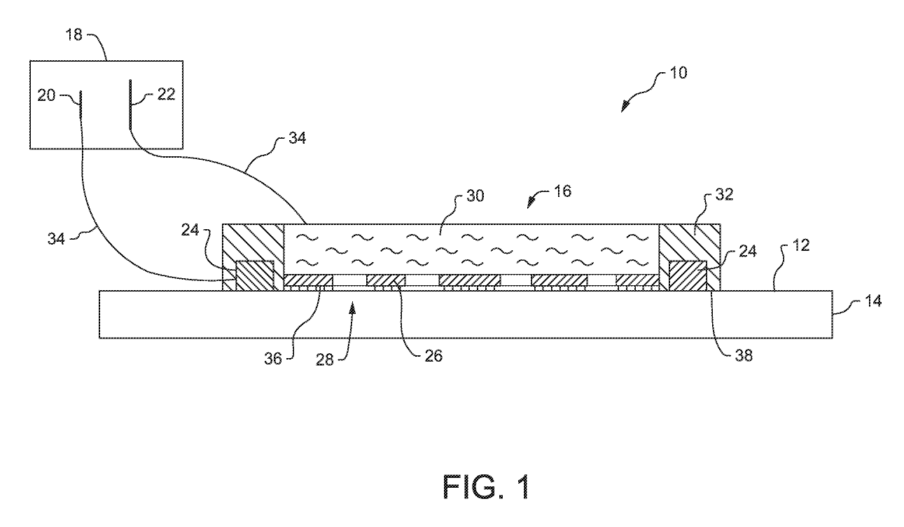

Referring now to the drawings, and with specific reference to FIG. 1, a bathless electromodification system 10 for electromodification of a conductive surface 12 of a part 14 is shown. As used herein, “electromodification” refers to either electroetching a conductive surface through site-selective metal removal from the conductive surface to create a marking on the surface, or site-selective electrodeposition of metal on the conductive surface to create a marking on the surface. In addition, as used herein, “bathless” means capable of operating without immersing the part to be electromodified in a container holding a bath of an electrolyte solution.

In general, the electromodification system 10 may include the part 14, an electromodification apparatus 16 that is placed in contact with the conductive surface 12 of the part 14 to be electromodified, and a power supply 18, such as a battery, having a negative terminal 20 and a positive terminal 22. The power supply 18 may apply electrical power with a predetermined polarity between the conductive surface 12 and a sacrificial metal 24 in the apparatus 16. The predetermined polarity of the power supply 18 may be either negative as applied to the conductive surface to allow metal electrodeposition at the conductive surface 12, or it may be negative as applied to the sacrificial metal 24 to allow metal removal (electroetching) from the conductive surface 12 (see further details below).

As the system 10 is bathless, it may facilitate electromodification of parts that are large and/or already installed. Specifically, the apparatus 16 may be placed in contact with the conductive surface 12 while the part 14 is installed or assembled in place to apply the marking on the surface without the need to submerge the part 14 in an electrolyte bath. In addition, when not precluded by the desired size of the marking, the apparatus 16 may be portable to facilitate repeated application of markings to various different part surfaces through electromodification.

The conductive surface 12 of the part 14 may be any type of conductive surface that is responsive to electromodification. As non-limiting possibilities, the conductive surface 12 may be a metallic surface, a metal clad composite surface, a partially metallic surface of a composite part, an electrically conductive surface of a composite part, or a metal coating or metal plating on a part. Although not necessary, the identity of a metal in the conductive surface 12 may match the identity of a metal in the sacrificial metal 24, or it may otherwise contain a metal that forms a compatible oxidation/reduction pair with a metal in the sacrificial metal 24. As non-limiting possibilities, the metal in the conductive surface 12 may include steel, iron, aluminum, copper, cobalt, nickel, titanium, zinc, or alloys of the aforementioned elements.

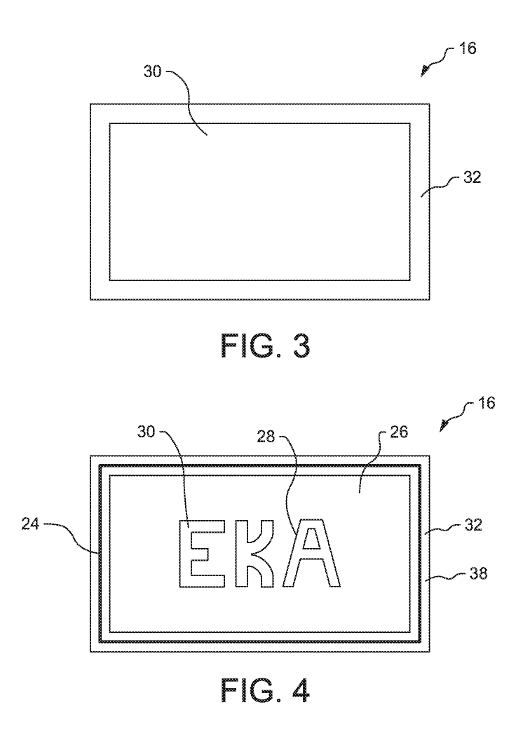

The electromodification apparatus 16 may include a stencil 26 having a mask pattern 28 or cut-out template in a shape of the desired marking (also see FIG. 4), a retainer 30 configured to capture or retain an electrolyte solution, and the sacrificial metal 24. The stencil 26, the retainer 30, and the sacrificial metal 24 may be mechanically joined together as a single integrated assembly, which may facilitate the portability and/or repeated use of the apparatus 16 on different parts. As one possibility, a frame 32 may be used to mechanically bind the stencil 26, the retainer 30, and the sacrificial metal 24 together as an integrated assembly (also see FIGS. 3-4).

The stencil 26 and the sacrificial metal 24 of the apparatus 16 may be placed in contact with the conductive surface 12 to be electromodified, as shown in FIG. 1. Using wire connections 34 or other suitable connections, the retainer 30 carrying the electrolyte solution may be connected to the positive terminal 22 of the power supply 18, and the sacrificial metal 24 may be connected to the negative terminal 20 of the power supply 18. As the conductive surface 12 may be in electrical contact with the electrolyte solution in the retainer 30 through the holes of mask pattern 28 in the stencil 26, the electrolyte solution may complete the electrical circuit between the sacrificial metal 24 and the conductive surface 12. Thus, in the arrangement of FIG. 1, the predetermined power polarity is negative as applied to the sacrificial metal 24 and positive as applied to the conductive surface 12 such that metal is removed from the conductive surface 12 exposed by the mask pattern 28 to create the marking on the conductive surface 12.

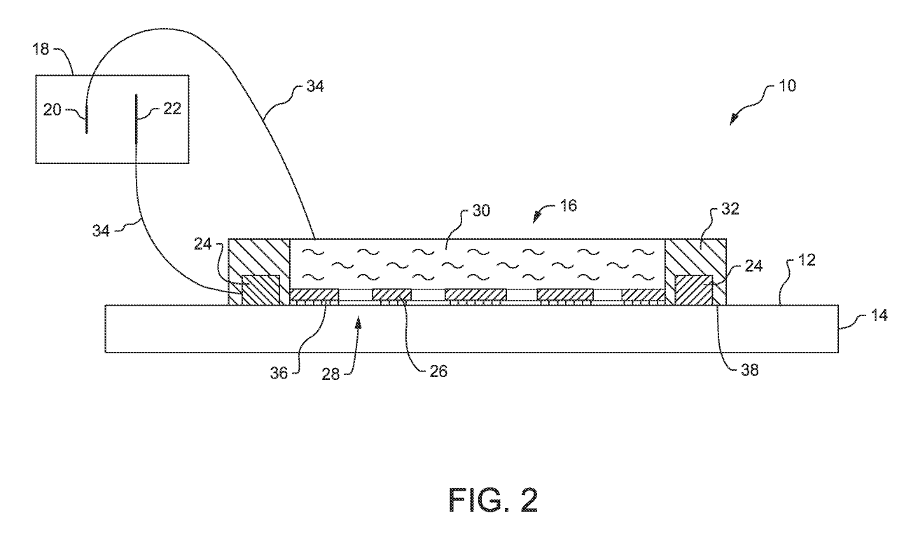

FIG. 2 shows the electromodification system 10 when the predetermined polarity is reversed with respect to FIG. 1 to allow electrodeposition of metal on the conductive surface 12. In this case, the sacrificial metal 24 is connected to the positive terminal 22 of the power supply 18, and the retainer 30 carrying the electrolyte solution is connected to the negative terminal 20 of the power supply 18. As the conductive surface 12 is in electrical contact with the electrolyte solution in the retainer 30 through the mask pattern 28, the polarity is negative as applied to the conductive surface 12 and positive as applied to the sacrificial metal 24. Accordingly, metal may be removed from the sacrificial metal and deposited at the conductive surface 12 exposed by the mask pattern 28 to create the marking.

Additional details of the components of the electromodification apparatus 16 will now be described. The stencil 26 may be formed from one or more materials that are impermeable to the electrolyte solution and are stable toward the conductive surface 12 and the retainer 30. For example, the stencil 26 may be formed from a plastic material, such as a vinyl polymer, although other materials may certainly be used. Optionally, a surface 36 of the stencil 26 that contacts the conductive surface 12 may have a temporary adhesive applied thereto so that the apparatus 16 may not need to be manually held in position during electromodification. The adhesive may also improve the resolution of the marking by preventing the apparatus 16 from moving during electromodification. Alternatively, or in combination with adhesive on the stencil 26, an adhesive may be presented on a bottom surface 38 of the frame 32 that contacts the conductive surface 12.

The retainer 30 may be one or more substances that chemically and/or mechanically retains the electrolyte solution through absorption or other chemical phenomena such as non-covalent binding. For example, the retainer 30 may include an absorbent fabric or material that absorbs the electrolyte solution. Suitable absorbent materials for this purpose may include, but are not limited to, cotton, felt, wool, linen, hemp or bamboo fabrics, paper, or suitable synthetic hydrophilic materials. In one example, the retainer 30 may be a cotton pad that is soaked or wetted with a sodium chloride solution. Chemical adsorbents for the electrolyte solution may include, but are not limited to, zeolites, silica gel, molecular sieves, polymer resins, or other materials capable of retaining an electrolyte solution in small pores and/or by non-covalent interactions such as hydrogen bonding. The electrolyte may include a metal salt that is of the same type of metal in the conductive surface 12 and sacrificial metal 24, although other electrolytes such as sodium chloride may also be used. The electrolyte may be dissolved in an aqueous or non-aqueous solution.

The frame 32 may be formed from a non-conductive material that prevents short circuits (unintended current paths) from being formed during electromodification. In this regard, suitable non-conductive materials for the frame may be non-conductive plastics, glass, porcelain, and rubber, although other materials may be used. As shown in FIGS. 3-4, the frame 32 may extend around a periphery of the apparatus 16 to hold the components of the apparatus 16 together. As one possibility, the frame 32 may extend around the periphery of the retainer 30 and the stencil 26, and the sacrificial metal 24 may be partially embedded in the frame 32. A portion of the sacrificial metal 24 may be exposed from the bottom surface 38 of the frame 32 to allow contacts with the conductive surface 12 (see FIG. 4). Although the exposed sacrificial metal 24 is shown as a continuous metal band extending around a periphery of the apparatus 16 in FIG. 4, the sacrificial metal 24 may instead be positioned at a defined location of the bottom surface 38 of the frame 32, or multiple sacrificial metals 24 may be distributed at various locations of the bottom surface 38. As explained above, the sacrificial metal 24 may include a metal that matches a metal in the conductive surface 12, or it may otherwise include a metal that forms a compatible oxidation/reduction pair with the conductive surface 12.

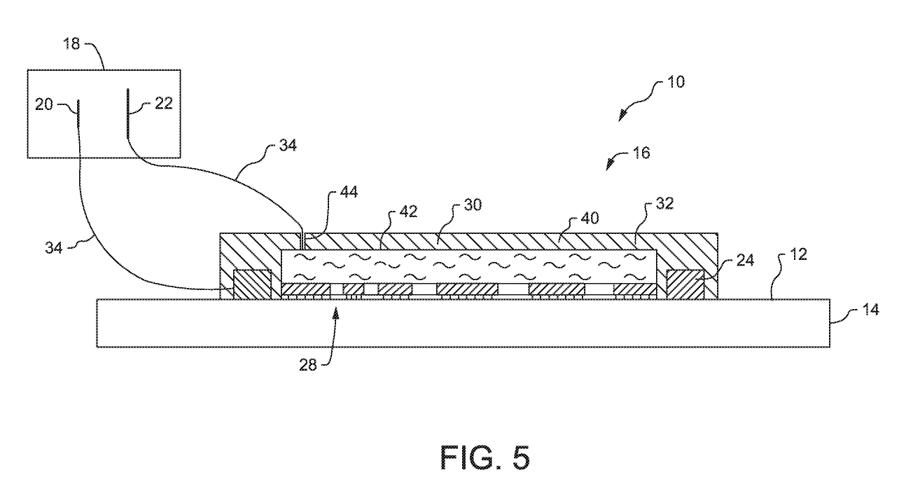

In an alternative arrangement of the apparatus 16, the frame 32 may include a backing 40 that covers at least a portion of a backside 42 of the retainer 30 (see FIG. 5). If the retainer 30 is completely blocked by the frame 32, a port 44 may optionally be included in the frame 32 to permit the wire connection 34 between the retainer 30 and the power supply 18. It will be understood that the predetermined power polarity in the arrangement of FIG. 5 may be either negative as applied to the sacrificial metal 24 and positive as applied to the conductive surface 12 (as shown) to allow electroetching of the conductive surface 12, or it may be negative as applied to the conductive surface 12 and positive as applied to the sacrificial metal 24 to allow metal electrodeposition on the conductive surface 12.

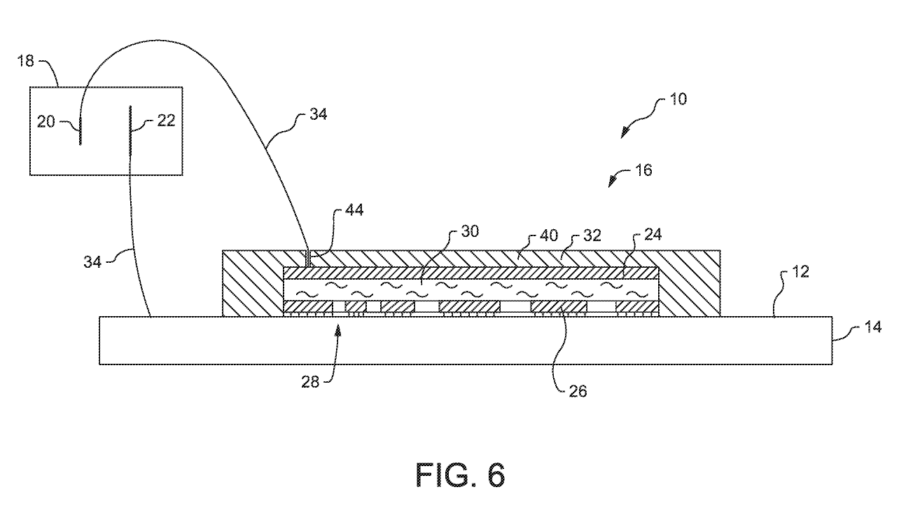

FIG. 6 shows another alternative arrangement of the apparatus 16 in which the sacrificial metal 24 is placed between the retainer 30 and the backing 40 of the frame 32. The predetermined electrical power polarity may be negative as applied to either the sacrificial metal 24 (as shown) or the conductive surface 12, with the electrolyte in the retainer 30 completing the electrical circuit between the sacrificial metal 24 and the conductive surface 12 through the mask pattern 28 in the stencil 26. As above, if the polarity is negative as applied to the sacrificial metal 24 and positive as applied to the conductive surface 12, metal may be removed from the conductive surface 12 exposed by the mask pattern 28 to provide the marking. If the polarity is negative as applied to the conductive surface 12 and positive as applied to the sacrificial metal 24, metal from the sacrificial metal 24 may be deposited at the conductive surface 12 exposed by the mask pattern 28 to provide the marking.

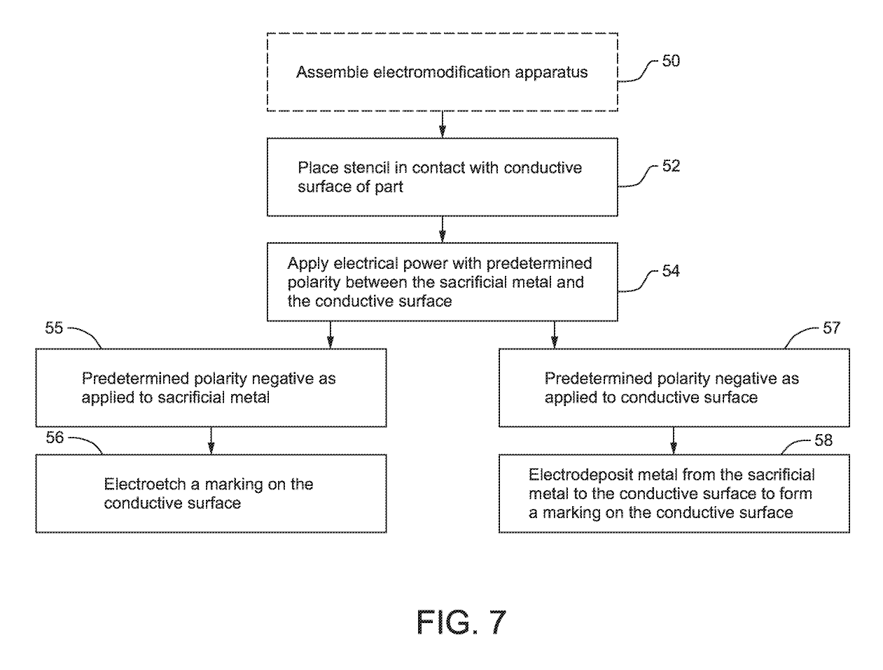

A series of steps that may be involved in electromodifying the conductive surface 12 using the apparatus 16 is shown in FIG. 7. The electromodification apparatus 16 may be pre-assembled or, if not, it may be assembled prior to use according to an optional block 50. The block 50 may involve inserting the retainer 30, the stencil 26, and the sacrificial metal 24 in the frame 32, with the sacrificial metal 24 being either partially embedded in the frame 32 (as in FIGS. 1-5) or placed between the frame 32 and the retainer 30 (as in FIG. 6). According to a next block 52, the stencil 26 of the assembled apparatus 16 may be placed in contact with the conductive surface 12 to be modified. The sacrificial metal 24 may also be placed in contact with the conductive surface 12 if it is exposed from the frame 32 as shown in FIGS. 1-5.

According to a next block 54, electrical power with a predetermined polarity may be applied between the sacrificial metal 24 and the conductive surface 12. The block 54 may involve connecting either the retainer 30 (as in FIGS. 1-5) or the part 14 (as in FIG. 6) to one of the terminals 20 or 22 of the power supply 18, and connecting the sacrificial metal 24 to the other terminal of the power supply 18. If electroetching of the conductive surface 12 is desired, the retainer 30 (or the part 14) may be connected to the positive terminal 22 and the sacrificial metal 24 may be connected to the negative terminal 20 such that the power polarity is positive as applied to the conductive surface 12 and negative as applied to the sacrificial metal 24 (block 55). Accordingly, metal may be removed (electroetched) from the conductive surface 12 to create the marking (block 56). Alternatively, if electrodeposition on the conductive surface 12 is desired, the sacrificial metal 24 may be connected to the positive terminal 22 and the retainer 30 (or the part 14) may be connected to the negative terminal 20 such that the power polarity is positive as applied to the sacrificial metal 24 and negative as applied to the conductive surface 12 (block 57). In the latter arrangement, metal from the sacrificial metal 24 may be transferred to and deposited on the conductive surface 12 to create the marking (block 58).

### INDUSTRIAL APPLICABILITY

In general, it can therefore be seen that the technology disclosed herein has industrial applicability in a variety of settings including, but not limited to, industries that may benefit from bathless electromodification of parts having conductive surfaces. The electromodification apparatus disclosed herein permits bathless, two-way electromodification of conductive surfaces of parts, wherein selected locations of the conductive surface may be electroetched or may have metal deposited thereon to create a marking on the surface. Specifically, the apparatus includes a sacrificial metal and a retainer that is capable of mechanically and/or chemically retaining an electrolyte solution by absorption or adsorption. When the apparatus is placed in contact with the conductive surface, the electrolyte solution in the retainer is in electrical contact with the conductive surface through the mask pattern of the stencil to allow either metal removal from the metal (electroetching) or metal deposition on the conductive surface (electrodeposition) depending on the applied predetermined power polarity. Although not limited to use with large or installed parts, the electromodification apparatus disclosed herein may greatly facilitate the application of markings to conductive surfaces of parts that are large, already installed, or otherwise difficult to immerse in an electrolyte bath. It is expected that the technology disclosed herein may find wide industrial applicability in a wide range of areas in which conductive surfaces are marked by electromodification such as, but not limited to, aerospace, automotive, sports, construction, and electronic industries.

What is claimed is:

1. An apparatus for electromodification of a conductive surface of a part, comprising:
a stencil having a mask pattern;
a retainer configured to capture an electrolyte, the retainer being joined to the stencil; and
a sacrificial metal joined to the stencil and the retainer to form an integrated assembly, the stencil being positioned in the assembly to (a) contact the conductive surface of the part, and (b) establish electrical contact through the mask pattern between the electrolyte and the conductive surface when electrical power with a predetermined polarity is applied between the sacrificial metal and the conductive surface.

2. The apparatus of claim 1, wherein the conductive surface is a metallic surface.

3. The apparatus of claim 1, wherein the conductive surface is a metal clad composite surface.

4. The apparatus of claim 1, wherein the conductive surface is a partially metallic surface of a composite part.

5. The apparatus of claim 1, wherein the conductive surface is a conductive surface of a composite part.

6. The apparatus of claim 1, wherein the predetermined polarity is negative as applied to the sacrificial metal.

7. The apparatus of claim 1, wherein the predetermined polarity is negative as applied to the conductive surface.

8. The apparatus of claim 1, wherein the retainer is one or more of an adsorbent and an absorbent material.

9. The apparatus of claim 8, wherein the absorbent material is cotton.

10. The apparatus of claim 1, wherein the stencil, the retainer, and the sacrificial metal are mechanically joined by a non-conductive frame, the sacrificial metal being partially embedded in the non-conductive frame, a portion of the sacrificial metal being exposed and positioned to contact the conductive surface of the part.

11. A method for electromodification of a conductive surface of a part, comprising:
providing an electromodification apparatus including a stencil having a mask pattern, a retainer supporting an electrolyte, a sacrificial metal, and a frame holding the stencil, the retainer, and the sacrificial metal together as an integrated assembly;
placing the stencil of the apparatus in contact with the conductive surface;
applying electrical power with a predetermined polarity between the sacrificial metal and the conductive surface, the stencil establishing electrical contact between the electrolyte and the conductive surface through the mask pattern; and
allowing electromodification of the conductive surface by one of electroetching the conductive surface, and electrodeposition of metal on the conductive surface.

12. A bathless electromodification system for electromodification of a conductive surface, comprising:
a part having the conductive surface;
an electromodification apparatus including
a stencil having a mask pattern, the stencil being in contact with the conductive surface of the part,
a retainer capturing an electrolyte,
a sacrificial metal, and
a non-conductive frame holding the stencil, the retainer, and the sacrificial metal together as an integrated assembly; and
a power supply to apply electrical power with a predetermined polarity between the sacrificial metal and the conductive surface to allow electromodification of the conductive surface, the stencil establishing electrical contact between the electrolyte and the conductive surface through the mask pattern.

13. The bathless electromodification system of claim 12, wherein the predetermined polarity is negative as applied to the sacrificial metal.

14. The bathless electromodification system of claim 12, wherein the predetermined polarity is negative as applied to the conductive surface.

15. The bathless electromodification system of claim 12, wherein the retainer is one or more of an adsorbent and an absorbent material.

16. The bathless electromodification system of claim 12, wherein the conductive surface is one or more of a metal surface, a metal clad composite surface, a partially metallic surface of a composite part, and a conductive surface of a composite part.

17. The bathless electromodification system of claim 12, wherein the part is installed.

18. The bathless electromodification system of claim 12, wherein the sacrificial metal is partially embedded in the non-conductive frame, a portion of the sacrificial metal being exposed and contacting the conductive surface.

19. The bathless electromodification system of claim 12, wherein the non-conductive frame includes a backing that covers the retainer.

20. The bathless electromodification system of claim 19, wherein the sacrificial metal is positioned between the backing of the non-conductive frame and the retainer.
